(19) United States
(12) Patent Application Publication
(10) Pub. No.: US 2006/0186183 A1
(43) Pub. Date: Aug. 24, 2006

(54) Wave solder nozzle

(75) Inventor: James M. Morris, Lebanon, MO (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Speedline Technologies, Inc., Franklin, MA (US)

(21) Appl. No.: 11/061,173

(22) Filed: Feb. 18, 2005

(51) Int. Cl. B23K 31/02

(52) U.S. Cl. 228/260; 228/37

(57) ABSTRACT

A wave solder nozzle is capable of delivering solder material to perform a wave soldering operation on a printed circuit board in an inert atmosphere. The wave solder nozzle includes a front plate and a back plate coupled to the front plate. The front plate and the back plate define a channel through which solder material flows. The nozzle further includes an exit trough extending from the back plate. The exit trough has a weir provided at one end of the exit trough. The exit trough is constructed and arranged to control the flow of solder material from the wave solder nozzle. A surface of the exit trough is wettable to improve the flow of solder material out of the wave solder nozzle. A method of improving the flow of solder material through the nozzle is also disclosed.

### BACKGROUND OF INVENTION

1. Field of Invention

The present invention relates generally to apparatus for manufacturing printed circuit boards and for assisting the process of soldering metals to integrated circuit boards, and more particularly to a wave soldering machine having an improved wave solder nozzle adapted to better control the flow of solder when performing a solder application on a printed circuit board.

2. Discussion of Related Art

Generally speaking, in a wave soldering machine, a printed circuit board (PCB) is moved by a conveyor on an inclined path past a fluxing station, a preheating station, and finally a wave soldering station. At the wave soldering station, a wave of solder is caused to well upwardly (by means of a pump) through a wave solder nozzle and contact portions of the PCB to be soldered. The efficiency of the soldering process is affected by a number of concerns, one of which is the ability to control the flow of solder material at the point of contact with the PCB and after the PCB moves away from the solder wave. Inconsistency of flow of solder material may cause inaccurate soldering applications.

Specifically, and with reference to FIG. 1, known solder wave nozzles adapted to perform soldering operations within an inert atmosphere are designed such that on the backflow (unload) side of the wave, solder material immediately drops from the nozzle. The inert atmosphere prevents the unwanted buildup of solder dross, which must be removed from the reservoir of solder material. As shown in FIG. 1, a nozzle 10 is configured with a front guide 12 and a back guide 14, which enable solder material 16 to flow on both sides of the solder wave. A PCB 18 is moved via a conveyor (not shown in FIG. 1) over the solder wave. A gas line 20 delivers inert gas (e.g., N₂) to the backside wave to prevent unwanted oxidants to contaminate the PCB 18 at the release point of the PCB from the solder wave.

One disadvantage with the inert solder wave nozzle 10 is that it is difficult to control the velocity of solder material being generated from the backside of the wave. It is known that optimum soldering results when the velocity V_{B} of the PCB 18 traveling over the wave is equal or substantially equal to the velocity V_{S} of the solder material flowing over the back guide 14 of the wave solder nozzle 10. Typically, the velocity of the solder wave is greater than the velocity of the PCB 18. The difference in the velocities of the PCB and solder wave results in a phenomenon called “bridging,” which is the undesirable interconnection of solder material between adjacent metallic pads of the PCB.

Solder wave nozzles adapted to operate within an oxygenated atmosphere are configured to reduce the velocity of solder material on the backside of the wave so that the velocity of solder material equals or substantially approximates the velocity of the PCB. Examples of such solder wave nozzles can be found in U.S. Pat. Nos. 3,921,888, 3,989,180 and 4,886,201. One disadvantage with known air nozzle designs is increased solder dross production.

### SUMMARY OF INVENTION

Embodiments of the invention provide improvements to wave solder nozzles, such as those described above.

A first aspect of the invention is directed to a wave solder nozzle adapted to deliver solder material to perform a wave soldering operation on a printed circuit board in an inert atmosphere. The wave solder nozzle comprises a front plate and a back plate coupled to the front plate. The front plate and the back plate define a channel through which solder material flows. The nozzle further comprises an exit trough extending from the back plate. The exit trough has a weir provided at one end of the exit trough. The exit trough is constructed and arranged to control the flow of solder material from the wave solder nozzle. A surface of the exit trough is wettable to improve the flow of solder material out of the wave solder nozzle.

In an embodiment of the invention, the wettable surface is located on a chamfered edge of the weir. In another embodiment, the wettable surface is fabricated from iron. In yet another embodiment, the wettable surface is fabricated from iron having less than 3% carbon. In a further embodiment, the wettable surface is fabricated from iron having approximately 0.2% carbon.

A second aspect of the invention is directed to a wave soldering machine to perform a wave soldering operation on a printed circuit board in an inert atmosphere. The wave soldering machine comprises a housing and a conveyor coupled to the housing. The conveyor is configured to deliver a printed circuit board to the housing. The wave soldering machine further comprises a wave soldering station coupled to the housing. The wave soldering station comprises a reservoir of solder material, and a wave solder nozzle in fluid communication with the reservoir. The wave solder nozzle comprises a front plate and a back plate coupled to the front plate. The front plate and the back plate define a channel through which solder material flows. The nozzle further comprises an exit trough extending from the back plate. The exit trough has a weir provided at one end of the exit trough. The exit trough is constructed and arranged to control the flow of solder material from the wave solder nozzle. A surface of the exit trough is wettable to improve the flow of solder material out of the wave solder nozzle. The wave soldering machine further comprises a controller to control the operation of the wave soldering machine.

In an embodiment of the invention, the wettable surface is located on a chamfered edge of the weir. In another embodiment, the wettable surface is fabricated from iron. In yet another embodiment, the wettable surface is fabricated from iron having less than 3% carbon. In a further embodiment, the wettable surface is fabricated from iron having approximately 0.2% carbon.

A third aspect of the invention is directed to a method of improving the flow of solder material out of a wave solder nozzle of a wave soldering machine in an inert atmosphere. The method comprises: delivering solder material to a wave solder nozzle; performing a wave soldering operation on a printed circuit board; and improving the flow of solder material over the wave solder nozzle by providing a surface of the wave solder nozzle with a wettable material.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a schematic cross-sectional view of a prior wave solder nozzle;

FIG. 2 shows a perspective view of a wave soldering machine of an embodiment of the present invention;

FIG. 3 shows a schematic cross-sectional view of a wave solder nozzle of an embodiment of the present invention;

FIG. 4 shows an enlarged view of a weir of the solder nozzle illustrated in FIG. 3; and

FIG. 5 shows an enlarged view of a solder material disposed on a surface of the wave solder nozzle illustrated in FIG. 3.

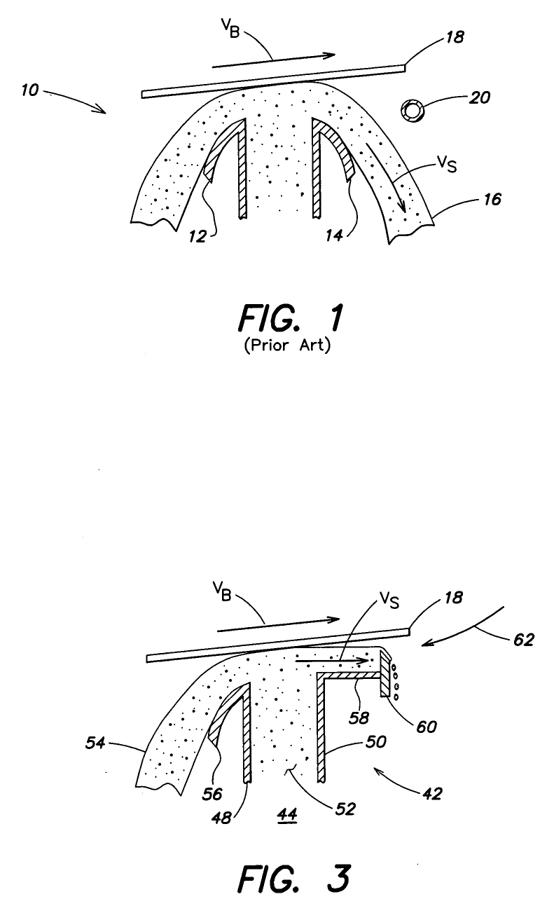

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

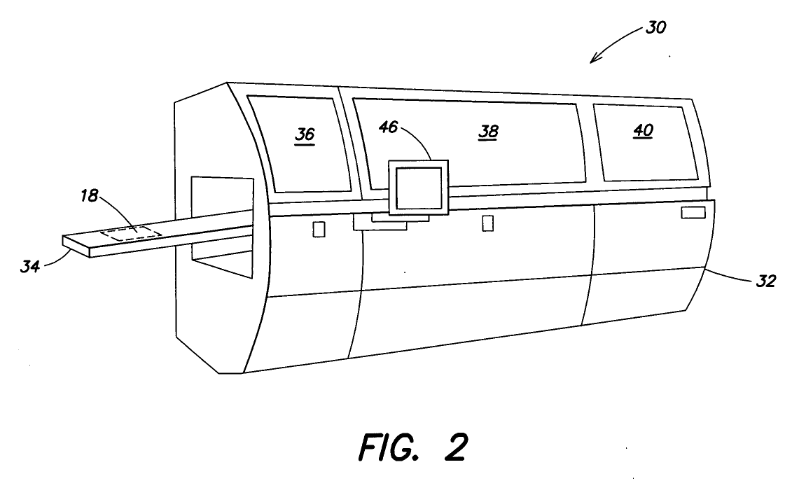

For purposes of illustration, and with reference to FIG. 2, embodiments of the present invention will now be described with reference to a wave soldering machine, generally indicated at 30, used to perform a solder application on a printed circuit board 18. The wave soldering machine 30 is one of several machines in a PCB fabrication/assembly line. As shown, the wave soldering machine includes a housing 32 adapted to house the components of the machine. The arrangement is such that a conveyor 34 delivers PCBs to be processed by the wave soldering machine 30. Upon entering the wave soldering machine 30, each PCB 18 travels along an inclined path past a fluxing station 36 and a pre-heating station 38 to condition the PCB for wave soldering. Once conditioned, the PCB 18 travels to a wave soldering station 40 to apply solder material to the PCB.

The wave soldering station 40 includes a wave solder nozzle, generally indicated at 42 in FIG. 3, in fluid communication with a reservoir 44 of solder material. A pump (not shown) is configured to deliver molten solder material to the wave solder nozzle 42 from the reservoir 44. Once soldered, the PCB 18 exits the wave soldering machine via the conveyor 34 to another station provided in the fabrication line, e.g., a pick-and-place machine. A controller 46 is provided to automate the operation of the several stations of the wave soldering machine 30, including but not limited to the fluxing station 36, the pre-heating station 38 and the wave soldering station 40, in the well known manner.

To prevent the bridging phenomenon and the unwanted build up of solder dross, one would expect that a system configured to combine an air nozzle design and an inert atmosphere would result in optimal performance. However, when inerting the atmosphere (e.g., an atmosphere with less than 100 ppm of O₂) of an air solder wave nozzle, the surface tension of the solder material greatly increases, thereby causing an inconsistent flow of solder material over the backside of the nozzle. Particularly, with existing air nozzles, solder material, e.g., lead-based (tin/lead), lead-free, etc., has a tendency to bead up on the nozzle, thus negatively affecting the laminar flow of solder material over the nozzle.

Referring to FIG. 3, the wave solder nozzle 42 of an embodiment of the invention is designed to perform within an inert atmosphere. Specifically, the wave solder nozzle 42 comprises a front plate 48 and a back plate 50 suitably coupled to the front plate. The front and back plates 48, 50 extend into the solder reservoir 44, which is configured to deliver molten solder material to the wave solder nozzle 42 by means of a pump (not shown). Together, the front and back plates 48, 50 define a channel 52 through which solder material 54 flows. The front plate 48 is formed with a front guide 56, which may be integrally formed with the front plate, or alternatively, may be formed by a separate sheet of metal attached to the front plate, as by welding. As shown, solder material 54 is adapted to spill over the front guide 56 back into the reservoir 44.

The back plate 50 of the wave solder nozzle 42 is formed with an exit trough 58, which extends generally perpendicularly from the back plate. The exit trough 58 is configured to vary the angle of the solder material 54 flowing over the exit trough. An adjustable weir or exit wing 60 is provided at the end of the exit trough 58 to control the level of solder material 54 flowing from the wave solder nozzle 42. Specifically, the weir 60 may be adjusted upwardly and downwardly to raise and lower the height of the solder wave, respectively. The wave solder nozzle 42 may be constructed, for example, in a manner similar to the construction of the wave solder nozzles disclosed in U.S. Pat. Nos. 3,921,888, 3,989,180 and 4,886,201, which are owned by Speedline Technologies, Inc., the assignee of the present invention, and incorporated by reference herein.

The provision of the exit trough 58 and the weir 60 control the flow of the solder material 54 from the nozzle 42. Specifically, the flow of solder material 54 may be controlled (e.g., by controller 46) so that the velocity V_{S} of the solder material is equal or substantially equal to the velocity V_{B} of the PCB 18.

As discussed above, the wave solder nozzle 42 shown in FIG. 3 is of the type configured to operate within an oxygenated atmosphere. Once an inert gas is introduced to the wave soldering station 40 as indicated by arrow 62, the surface tension of the solder material 54 increases and causes an inconsistency in the height and flow characteristics of the solder wave. Surface tension of the solder material 54 increases when molten solder is placed in an atmosphere that is non-oxidized. When oxygen is present, microscopic particles in the solder (e.g., tin/lead solder) oxidize to form dross on the solder surface which has the result of reducing the surface tension of the solder. Thus, the solder material sufficiently wets the surface of the trough to enable the solder material to flow properly. When an inert gas (e.g., N₂) is introduced, the solder surface is not contaminated with the microscopic particles with the result of increasing the surface tension, which restricts the flow of solder over the trough.

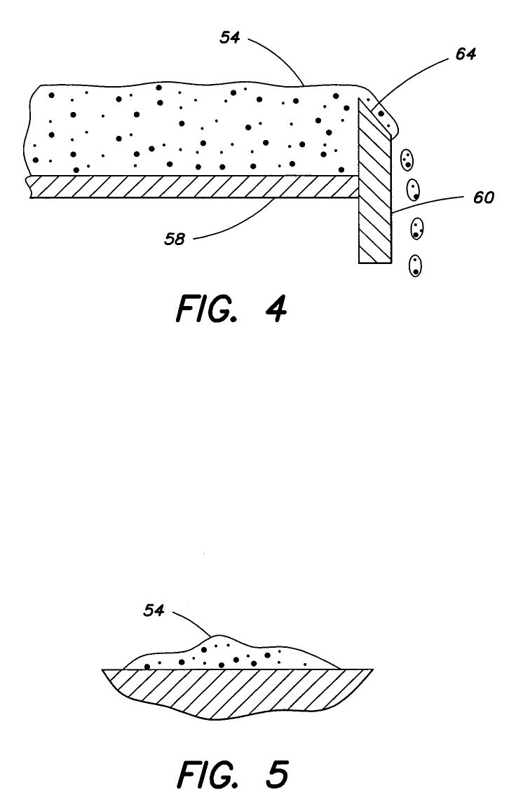

Referring to FIG. 4, the weir 60 is constructed with a chamfered edge 64, which is configured to enable the flow of solder material 54 out of the exit trough 58. Preferably, the chamfered edge 64 extends at a 20° angle with respect to a vertical plane. However, any angle may be chosen to optimize the laminar flow of solder material 54 over the edge of the weir 60. As shown, solder material 54 flows generally evenly over the edge of the weir 60 and along the chamfered edge 64. Upon exiting the exit trough 58, the solder material 54 separates into droplets, which spill into the reservoir 44.

To enable the operation of the solder wave nozzle 42 within an inert atmosphere, the exit trough 58 in general, and the weir 60 in particular, may be fabricated from a material that enables the solder to wet on surfaces to better the flow of material. As shown in FIG. 5, molten solder material 54 spreads over the wettable surface. Specifically, the chamfered edge 64 may be fabricated or treated with a wettable material. The provision of a wettable surface eliminates the surface tension issue described above. Although a particular advantage is gained by fabricating or treating the chamfered edge 64 from wettable material, it is envisioned, based on the teachings of the instant disclosure, that the surfaces on the exit trough 58 and the weir 60 upon which solder material travels may be fabricated or otherwise treated with wettable material to further improve the flow of material out of the exit trough.

In one embodiment, the wettable material is iron. Preferably, the wettable material is fabricated from iron impregnated with less than 3% carbon. Most preferably, the wettable material is fabricated from iron impregnated with approximately 0.2% carbon. Other materials and alloys may further be chosen, and include: grey cast iron; cast iron; stainless steel; chrome-plated steel; nickel; titanium; and copper. For example, it is contemplated that stainless steel treated with a very strong acid will provide sufficient wettability to enable molten solder material 54 to flow evenly over the weir 60. Notwithstanding, low carbon iron demonstrated the best results.

In one embodiment of the invention, the chamfered edge 64 is electroplated with pure iron or low carbon iron (e.g., 1018 steel). Other suitable methods may also be employed.

In another embodiment of the invention, a method of improving the flow of solder material out of a wave solder nozzle of a wave soldering machine is further disclosed. The method includes: delivering solder material to a wave solder nozzle; performing a wave soldering operation on a printed circuit board; and improving the flow of solder material over the wave solder nozzle by providing a surface of the wave solder nozzle with a wettable material. This method may be achieved by employing nozzle 42 described above.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A wave solder nozzle adapted to deliver solder material to perform a wave soldering operation on a printed circuit board in an inert atmosphere, the wave solder nozzle comprising:
a front plate;
a back plate coupled to the front plate, the front plate and the back plate defining a channel through which solder material flows; and
an exit trough extending from the back plate, the exit trough having a weir provided at one end of the exit trough, the exit trough being constructed and arranged to control the flow of solder material from the wave solder nozzle,
wherein a surface of the exit trough is wettable to improve the flow of solder material out of the wave solder nozzle.

2. The wave solder nozzle of claim 1, wherein the wettable surface is located on the weir.

3. The wave solder nozzle of claim 1, wherein the weir comprises a chamfered edge.

4. The wave solder nozzle of claim 3, wherein the wettable surface is located on the chamfered edge.

5. The wave solder nozzle of claim 1, wherein the wettable surface is fabricated from iron.

6. The wave solder nozzle of claim 1, wherein the wettable surface is fabricated from iron having less than 3% carbon.

7. The wave solder nozzle of claim 1, wherein the wettable surface is fabricated from iron having approximately 0.2% carbon.

8. A wave soldering machine to perform a wave soldering operation on a printed circuit board in an inert atmosphere, the wave soldering machine comprising:
a housing;
a conveyor coupled to the housing, the conveyor being configured to deliver a printed circuit board to the housing;
a wave soldering station coupled to the housing, the wave soldering station comprising
a reservoir of solder material, and
a wave solder nozzle in fluid communication with the reservoir, the wave solder nozzle comprising a front plate, a back plate coupled to the front plate, the front plate and the back plate defining a channel through which solder material flows, and an exit trough extending from the back plate, the exit trough having a weir provided at one end of the exit trough, the exit trough being constructed and arranged to control the flow of solder material from the wave solder nozzle, wherein a surface of the exit trough is wettable to improve the flow of solder material out of the wave solder nozzle; and
a controller to control the operation of the wave soldering machine.

9. The wave soldering machine of claim 8, wherein the wettable surface is located on the weir.

10. The wave soldering machine of claim 8, wherein the weir comprises a chamfered edge.

11. The wave soldering machine of claim 11, wherein the wettable surface is located on the chamfered edge.

12. The wave soldering machine of claim 8, wherein the wettable surface is fabricated from iron.

13. The wave soldering machine of claim 8, wherein the wettable surface is fabricated from iron having less than 3% carbon.

14. The wave soldering machine of claim 8, wherein the wettable surface is fabricated from iron having approximately 0.2% carbon.

15. A method of improving the flow of solder material out of a wave solder nozzle of a wave soldering machine in an inert atmosphere, the method comprising:
delivering solder material to a wave solder nozzle;
performing a wave soldering operation on a printed circuit board; and
improving the flow of solder material over the wave solder nozzle by providing a surface of the wave solder nozzle with a wettable material.
